(19) United States
(12) Patent Application Publication
(10) Pub. No.: US 2016/0097156 A1
(43) Pub. Date: Apr. 7, 2016

(54) CONTINUOUS TENSILE SYSTEM WITH MULTI-STAGE BRAIDING

(71) Applicants: CALIFORNIA INSTITUTE OF TECHNOLOGY, PASADENA, CA (US); PIONEER AEROSPACE CORPORATION, SOUTH WINDSOR, CT (US)

(72) Inventors: John C. GALLON, PASADENA, CA (US); Erich J. BRANDEAU, PASADENA, CA (US); Tommaso P. RIVELLINI, MONTROSE, CA (US); Douglas ADAMS, PASADENA, CA (US); Allen WIKOWSKI, SOUTH WINDSOR, CT (US)

(21) Appl. No.: 14/869,767

(22) Filed: Sep. 29, 2015

Related U.S. Application Data
(60) Provisional application No. 62/058,204, filed on Oct. 1, 2014.

(51) Int. Cl. D07B 1/18; D07B 9/00; B64D 17/24

(52) U.S. Cl. CPC D07B 1/18; B64D 17/24; D07B 9/00; D07B 2401/2055

(57) ABSTRACT

A continuous tensile system is disclosed. The system is braided from individual ropes that form bridle legs, riser, and extension lines in a parachute system. The continuous nature of the braided system allows load sharing between strands and an increased mass efficiency for the breaking system of a payload.

### CROSS REFERENCE TO RELATED APPLICATIONS

The present application claims priority to U.S. Provisional Patent Application No. 62/058,204, filed on Oct. 1, 2014, the disclosure of which is incorporated herein by reference in its entirety.

### STATEMENT OF INTEREST

The invention described herein was made in the performance of work under a NASA contract, and is subject to the provisions of Public Law 96-517 (35 USC 202) in which the Contractor has elected to retain title.

### TECHNICAL FIELD

The present disclosure relates to parachutes. More particularly, it relates to a continuous suspension system involving multi-stage braiding for a parachute's skeletal structure, which includes the primary tensile elements of a parachute.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 illustrates a metallic confluence fitting used as a union of individual tensile members.

FIG. 2 illustrates the metallic confluence fitting during a mortar deployment of the parachute.

FIG. 3 illustrates the location of the confluence fitting on a parachute.

FIG. 4 illustrates an exemplary braided tensile system used as a parachute's riser-bridle.

FIG. 5 illustrates exemplary interface of braided riser-bridle to a parachute's suspension lines.

FIG. 6 illustrates an exemplary confluence whipping.

FIG. 7 illustrates exemplary confluence wrap.

FIG. 8 illustrates an exemplary continuous tensile system under test.

FIG. 9 illustrates a confluence wrap under test.

FIG. 10 illustrates deployment of a braided riser-bridle.

FIG. 11 illustrates structural loading of braided riser-bridle.

FIG. 12 illustrates an exemplary braided riser-bridle.

FIG. 13 illustrates use of a continuous tensile system with multi-stage braiding applied to a parachute.

FIG. 14 illustrates the use of six strands to generate a 12-strand braid.

FIG. 15 illustrates the use of 12 strands to generate a 12-strand braid.

FIG. 16 illustrates details of the confluence wrap.

FIG. 17 illustrates details of the jumpers and wraps of confluence.

FIG. 18 illustrates a schematic of the confluence wrap.

### SUMMARY

In a first aspect of the disclosure, a continuous tensile system braided from a plurality of ropes is described, the system comprising: a plurality of bridle legs braided from the plurality of ropes; a riser braided from the plurality of bridle legs; a first confluence joint between the plurality of bridle legs and the riser; and a second confluence joint between the riser and a plurality of extension lines, each extension line being a rope of the plurality of rope which is unbraided from the riser.

### DETAILED DESCRIPTION

Trailing aerodynamic decelerators, such as parachutes, rely on a flexible tensile system to transmit aerodynamic drag forces to a payload. In parachutes this tensile system is comprised of various separate components, including bridles connected to the payload, a single riser that allows decoupling of the parachute from the payload, suspension lines that distribute the force amongst the drag area and radials that connect the suspension lines to the broadcloth. Typically these components are synthetic cordage or webbing, but may also be made of organic materials. Confluence points, where multiple components converge at a single point, exist to increase the number of degrees of freedom and decouple the payload from the decelerator. The parachute is usually attached to the payload with single or multiple bridle legs in order to provide a kinematic connection. Because of the multiple load vectors converging at the confluence point, a structural-metallic confluence fitting is usually employed to accommodate the various load vectors.

In general parachute terminology, a bridle leg (also called a sling) is typically a webbing strap that provides an interface between the parachute assembly and the suspended object; for example, it may be from a pilot chute to the top of a main canopy, or a series of them may connect a cargo pallet to a parachute cluster. In general parachute terminology, a riser is typically a webbing strap that provides the interface between the parachute suspension lines and the suspended object; for example, a riser provides the connection from a parachute's suspension lines to a harness or confluence fitting. In general parachute terminology, the suspension lines are typically multiple cords that provide the interface between the canopy fabric and the riser or risers. In the primary tensile structure of a parachute there are typically many different elements connected with joints. The transition between these elements typically results in a reduction of strength at the joints. This reduction in element strength results in higher than required element strength such that adequate system strength is achieved. The consequence of this is an increased system mass as each element is made stronger, and therefore heavier, when compared to the mass required when a system has an efficient joint. This is particularly penalizing in parachute systems because of the long length of the tensile elements that make up the structural skeleton.

On typical large parachute systems a custom metallic confluence fitting is used to provide the interface between the riser and bridle legs. These confluence fittings typically use bolted pin connections to attach to the bridle to the riser (or risers), effectively acting as the vertex of a tripod structure. As drag devices get larger and forces increase, these confluence fittings must also grow in size and mass to become stronger. For aerospace parachute applications mass savings is an important issue.

This type of metallic confluence fitting poses problems to the parachute systems:

1. In a typical mortar deployment of a parachute, where a mortar is employed to shoot and deploy the parachute out of the vehicle, the confluence fitting must be packed inside the parachute pack. The parachute is packed very tightly with many tons of force, creating pack densities up to 48 lbm/cubic foot. Pressure packing soft materials (typical parachutes are made with Nylon and polyester or Kevlar) around a metallic fitting creates a risk of damaging the parachute and/or the confluence fitting. Typically, to mitigate this damage, the fitting must be wrapped in a buffer material such as nylon, kevlar and/or Teflon fabrics. This buffer material serves no structural function and results in scar mass once the parachute is deployed. For planetary parachutes, the packs are often X-rayed to verify that the confluence fitting wasn't damaged during the packing process.

2. During the deployment of the parachute and rigging, the point mass of the confluence fitting causes large snatch forces in the rigging. The confluence fitting is ejected at a high velocity from the mortar with the pack and snatches against the vehicle. As the confluence fitting gets heavier and parachutes get larger, this snatch force increases. The deployed confluence fitting also poses a hazard to other hardware in the vicinity, because it acts as a point-mass and can potentially damage anything that it contacts during the deployment.

3. The mass of the confluence fitting becomes a significant portion of the decelerator system mass as the drag increases. In large parachute systems, this increased size, and thus mass, results in unfavorable deployment dynamics. Having a point mass, i.e. the metallic fitting, causes a linear mass discontinuity, which results in erratic and undesired line dynamics during deployment and parachute inflation. In the case of atmospheric entry bodies (payloads), which are designed to have as low of a ballistic coefficient as possible, the environment of parachute deployment is performed in a relatively high deceleration frame. Having a heavy metallic confluence, coupled with a large parachute system that takes time to extract to line stretch, results in an increased risk of backsliding of the rigging toward the payload. This is highly undesired as it results in the parachute rigging (bridles and risers) piling up uncontrollably on the back of the payload, and then when the parachute inflates, the slack rigging is snatched off of the payload, potentially snagging hardware on its exit, and then causing a snatch force when tensile members all align. This induces snag risks, undesired dynamic loading, and can produce undesired payload dynamics.

4. The cost of the metallic confluence fitting is high. In an attempt to keep the mass low as possible, materials with low mass and high strength, such as titanium, are often used and are typically expensive to buy the bulk material and machine. The fabrication costs for the braided-riser-bridle (BRB) of the present disclosure are significantly less; an entire braided system costs approximately an order of magnitude less than a system of typical design (risers, fitting, and bridle legs) with the same load carrying capability.

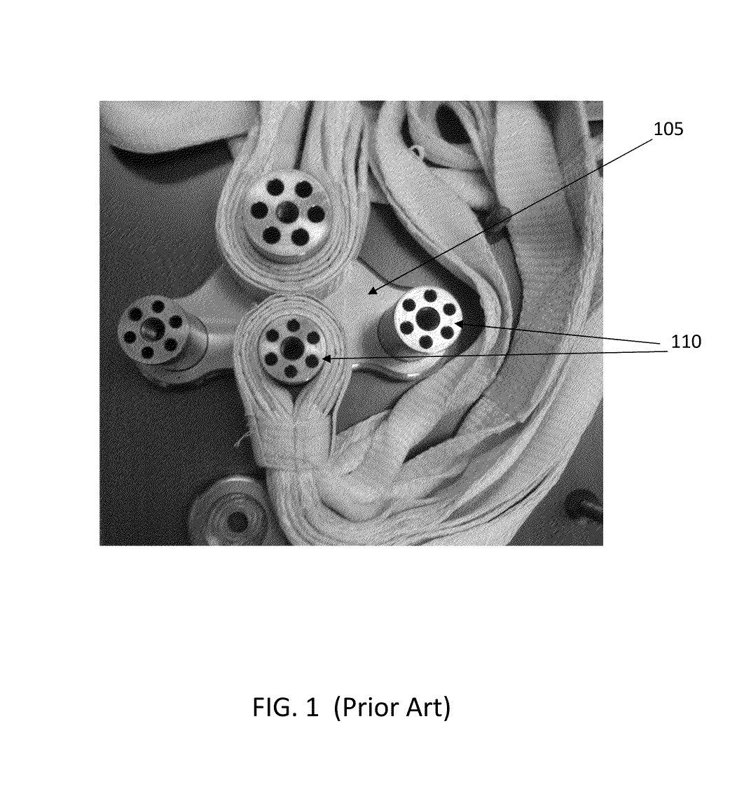

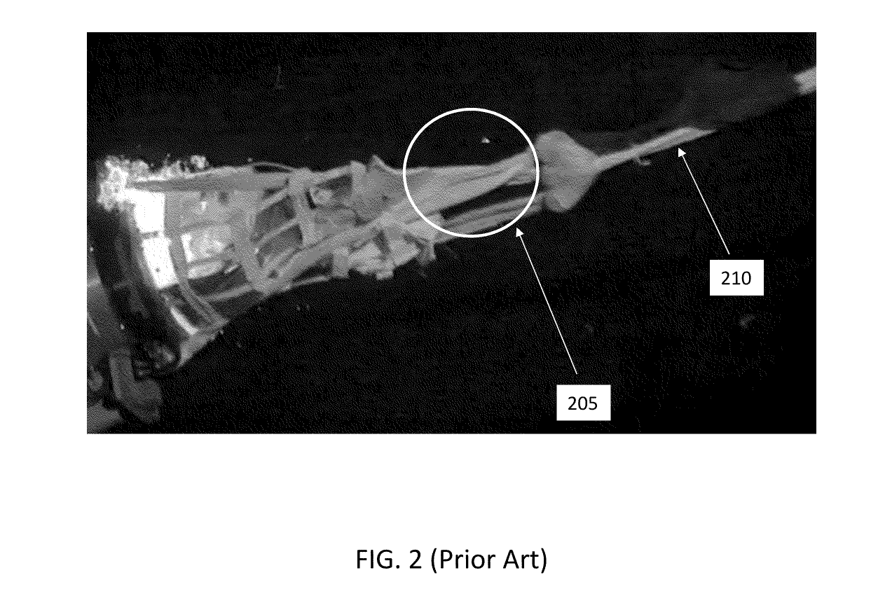

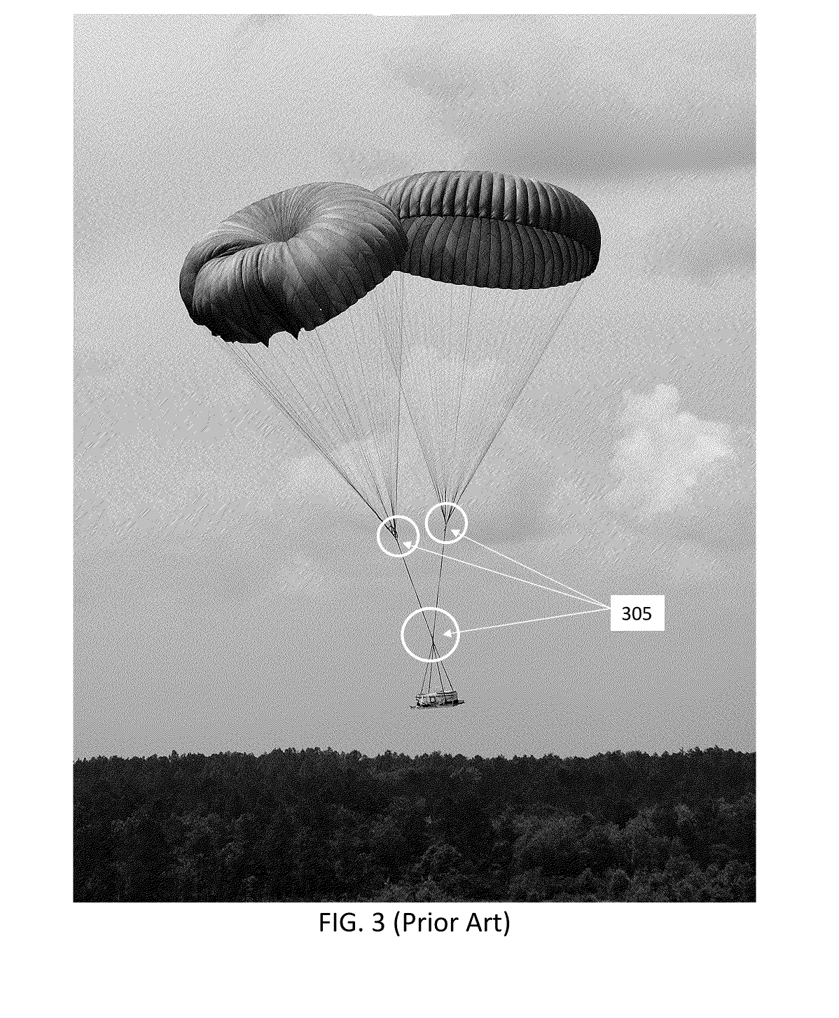

FIG. 1 illustrates a metallic confluence fitting (105). In FIG. 1, the outer plate of the fitting is off, showing the inner pins (110). FIG. 2 illustrates a confluence fitting (205) during a mortar deployment of the parachute. In FIG. 2, the fitting is wrapped in a buffer material. The single riser of the parachute system can be seen (210). FIG. 3 illustrates the exemplary locations of the confluence fittings in a typical cargo drop. (305).

As described in the present disclosure, a lighter and more mass efficient parachute pack and improved deployment dynamics can be achieved if the metallic confluence fitting is eliminated. This can be achieved by creating a continuous tensile system that eliminates joints and metallic fittings.

On the Low Density Supersonic Decelerator (LDSD), the metallic confluence fitting was eliminated and a “Braided Riser-Bridle” (BRB) was developed to replace the traditional bridle, confluence fitting, and riser. The BRB retains the same geometry as that of the previous system with a metallic fitting, but does so with a single part. In some embodiments, the BRB resembles a custom lifting sling with three legs transitioning to a single leg transitioning to twelve legs. The sling is made from twelve individual ropes (or strands) that are braided together at a section to become the single leg. Each rope is itself a braided system and commercially available ropes can be used to be braided together. The braiding allows the twelve strands to share the load, which in turn enables the sling to be asymmetrically and unevenly loaded. For example, if the strands of a twelve-stranded BRB were labeled A-L, strands A, B, C and D could be loaded at one end of the braid, and strands F through L could be loaded at the opposite end of the bridle. The single braid, through the braiding, allows load-sharing in the riser and transfers the load out to the legs that are in tension. As part of the development and verification testing, asymmetric loading cases as described above were applied to both scaled and full size test articles. In all cases the BRB passed the structural qualification tests. For example, asymmetric loading can occur if some ropes are carrying a greater part of the load. During deployment, asymmetrical loading may occur. The loading may then even out, depending on the dynamic situation during a fall through the atmosphere.

The number of individual ropes or carriers can be tailored to the design requirements of the parachute system. For instance, if four legs were required, the twelve carriers could be divided in groups of three instead of four at the bridle section, or sixteen carriers could be used and maintain the four carriers per leg, however this would result in sixteen individual loops at the top. If an entire parachute tensile structure is fabricated using this technique, then the number of parachute gores, and thus continuous suspension lines, can be divided using this same process through multiple stages of braiding. For example 96 gores/suspension lines can be braided into 12 eight-strand braids, then the 12 strands be braided to one riser with 12 strands, then the braid could be split out to three legs going to the suspended payload. In all these embodiments, an even number of strands or braids is used.

The braid must be radially constrained at each transition of braiding stages. In practice a whipping (or wrap) is used to laterally constrain the braid where multiple load vectors are converging. This prevents the next stage of braiding from opening or compressing the weave, as well as constraining the location of the transition. This is known as a confluence.

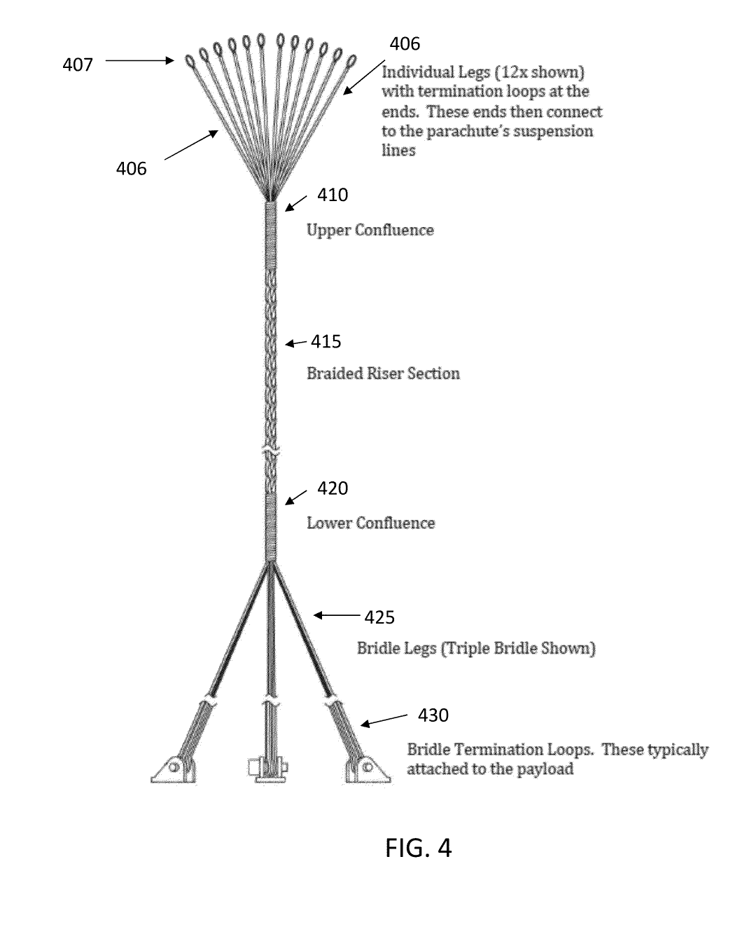

FIG. 4 illustrates an exemplary braided riser-bridle. In FIG. 4, twelve individual legs (406) with termination loops (407) comprise the attachment to suspension line (not shown). An upper confluence (410) constrains the legs (406) in the braided riser section (415). A lower confluence (420) constrains the bridle legs (425) in the braided riser section (415). In this embodiment, there are three bridle legs (425) that end in bridle termination loops (430), which can be attached to a payload.

The choice of cordage was made for three primary reasons: 1) Cordage is readily braided 2) Cordages allow for the termination of the ends with high efficiency using an eye-splice. This requires no structural stitching and the termination joint area remains compliant (flexible). 3) Cordage has a higher strength to weight ratio as compared to webbings that consist of warp and fill strands.

As known to the person of ordinary skill in the art, cordage is a generic term that covers different types of cords, lines, ropes, and strings. Webbing is a textile product such as a woven ribbon, strapping, or tape. Webbing unravels when cut, a feature which distinguishes it from cordage and rope. Cordage, rope and webbing are often made of synthetic or polymer materials, natural fibers such as cotton and wool, and acetate and triacetate fibers. Some cordage, rope and webbing are made of glass or fiberglass, ceramic, or metallic fibers. Others are made of blended fiber structures.

Different types of braiding could be used for the riser section of the BRB. In some embodiments, the most effective braid was a two-over-two-under braid. This is typically the braid found in many cordages. The person of ordinary skill in the art will understand that a two-over-two-under braid is a weaving pattern used in braiding, where the strands forming a braid will be woven over or under another strand, in a specific pattern. For a one-over-one-under braid, for example, a strand will pass over another strand once, and then under another strand once, in turn, but will not pass over or under two other strands consecutively. For a two-over-two-under braid, a strand will pass over two other strands, consecutively, before passing under two other strands.

For a twelve-carrier braid, six lines wrap in one direction down the braid, and the other six wrap the opposite direction. That is, when the lines (or strands) of the braid are woven together, six lines will start to weave inwardly towards the longitudinal axis of the braid, while the other six remaining lines will wrap inwardly as well, to be interwoven with the other six lines. Rather than the lines crossing under and over each time they meet, the two-over-two-under braid passes over two strands before going under the next two they meet as the braid is wrapped. This method was found to be optimal for the braided section as it allows the braid, when loaded, to fully collapse to a tight bundle, as opposed to other braiding methods, like the one-over-one-under braid, which left the core of the braid open when loaded. Also it was found that when the braid was fully collapsed the pressure between the strands allowed for higher load sharing, which was a critical design feature that was required for the continuous tensile system to functionally share load between individual strands transitioning into a single braid. It was found that, in some embodiments, a minimal length of the braided section may be required. Too short of a braided section does not provide enough engaged length to allow for the strands to adequately load share amongst the neighboring strands in the woven section. In cases where the braided section was too short, the loaded braid members would pull out of the braid rather than transferring their load to the other braid strands within the braided section. The minimal length may depend on the specific application.

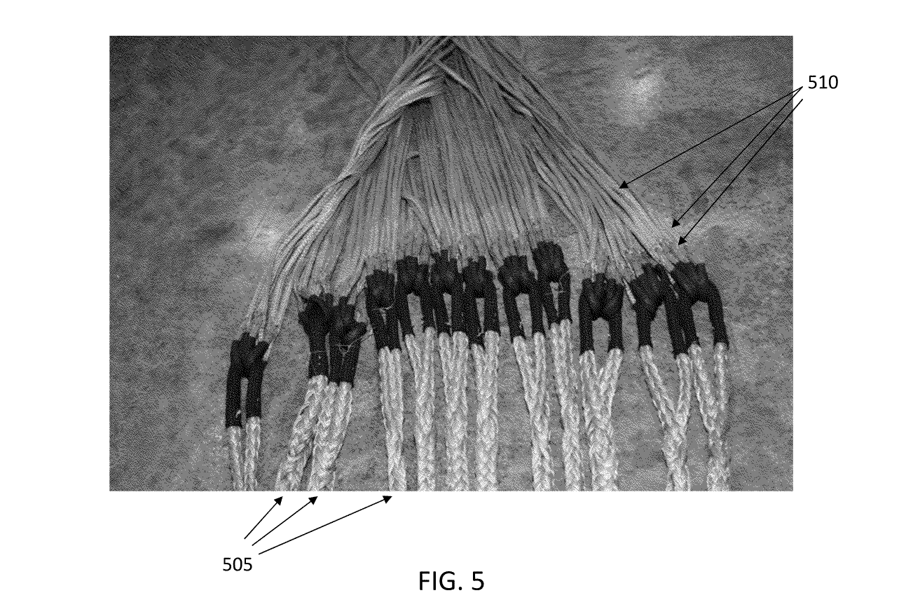

FIG. 5 illustrates an exemplary braided strand termination. In this example, twelve braided strands (505) have splice eye loops that connect to 96 parachute smaller cordage lines (510).

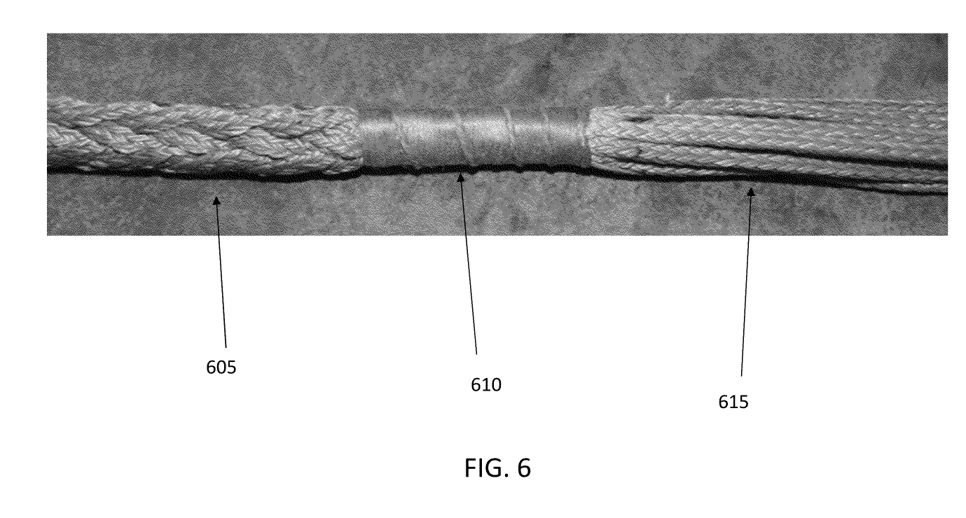

There are multiple ways to create confluences in the present disclosure. One embodiment is a whipping style wrap around the braid at each braided stage transition. Whipping is done by tightly wrapping a smaller diameter cordage with a series of locking half-hitches around the end of the braided section, thus allowing the braid to stop and transition to individual cords. This approach works well as long as the whipping can handle the radially outward forces that result from the spreading force. If the radial spreading forces are too high for the whipping, the failure could manifest itself in either a structural failure of the whipping cordage, or sliding of the entire whipping into the braided section, given the continuous strands do not fail. In FIG. 6, a braided section (605) transitions to the individual cordages (615) through a confluence (610) that maintains the transition location.

When the leg geometry results in a high cone angle the confluence whipping method can be improved upon. Specifically, in a second embodiment a loose confluence wrap can be used instead of a whipping wrap. The confluence wrap consists of multiple wraps of stranded braid. This loose wrap can be constrained to each of the legs via structural jumpers that are spliced into the leg sections. These jumpers do not allow the wrap to slide up the riser braid, even when angles are extremely high, resulting in high spreading and axial forces.

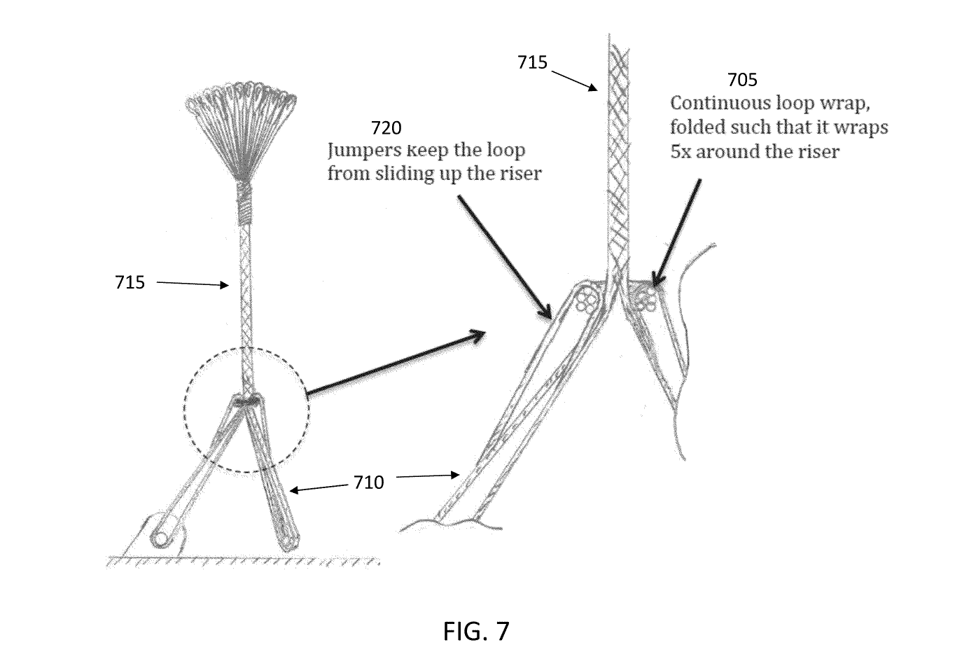

FIG. 7 illustrates the confluence wrap design embodiment, which is shown, in this example, with five wraps (705) around the confluence of the individual strands of the bridle legs (710) to the braided section of the riser (715). In this design a continuous loop of cordage was used and was sized to be able to handle the radial spreading forces of the bridle legs (710). The confluence loop wrap was secured in place by splicing jumpers (720) into the legs coming up to the confluence. These jumpers (720) keep the confluence wrap from sliding up the riser (715). This design was analyzed to be more capable in cases of high bridle angles as compared to the whipping technique. Mechanical tensile testing of this geometry was conducted and validated the analytical models.

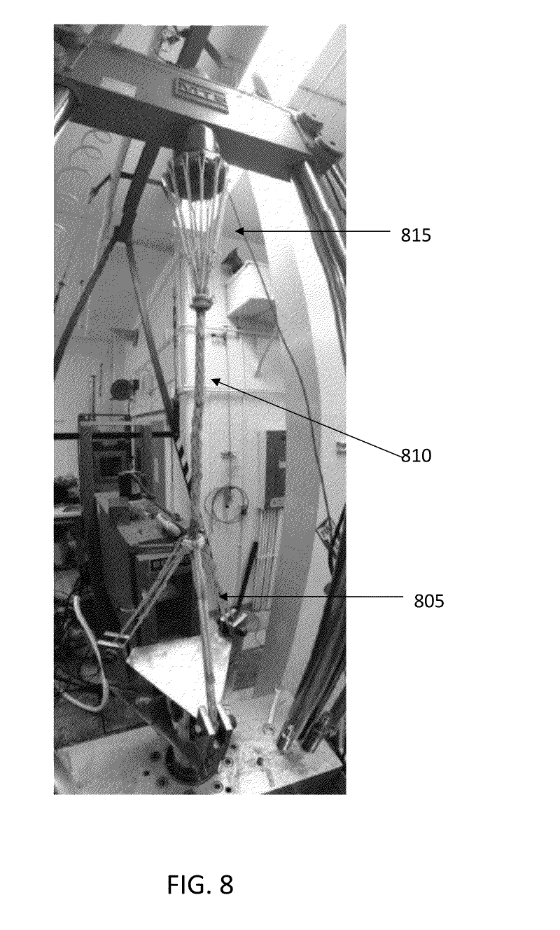

FIG. 8 illustrates an exemplary braided riser bridle in a mechanical tensile testing apparatus. FIG. 8 shows the bridle legs (805) transitioning into the braided riser (810) and the individual strands (815).

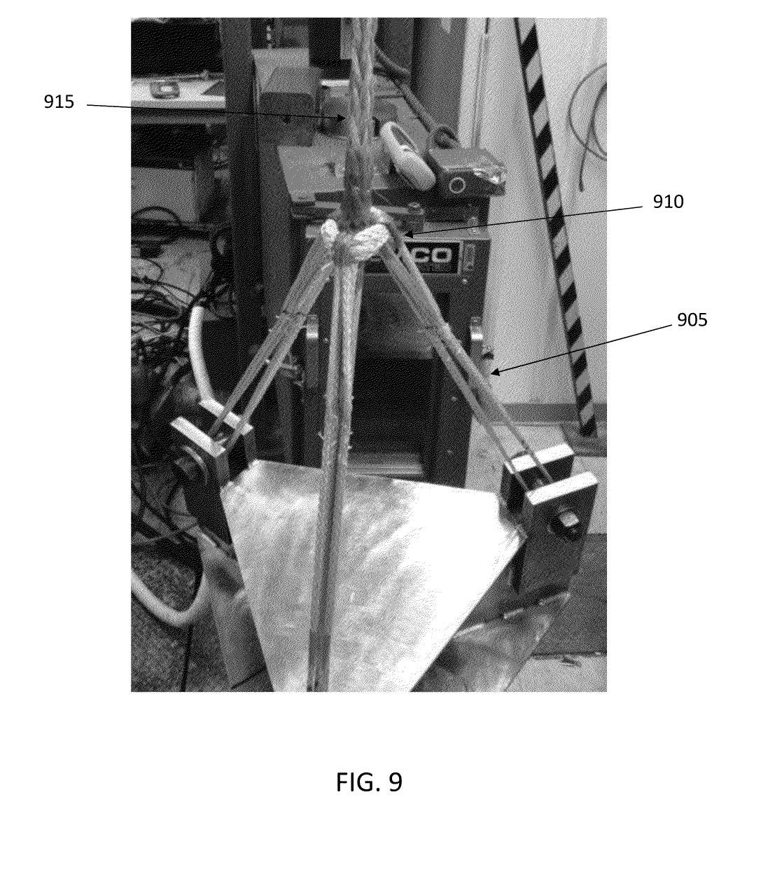

FIG. 9 illustrates an exemplary confluence wrap (910) as in FIG. 7. Testing of this nature validated the structural capability of the confluence wrap design with jumpers. FIG. 9 illustrates the bridle legs (905), the riser (915) and the confluence wrap (910).

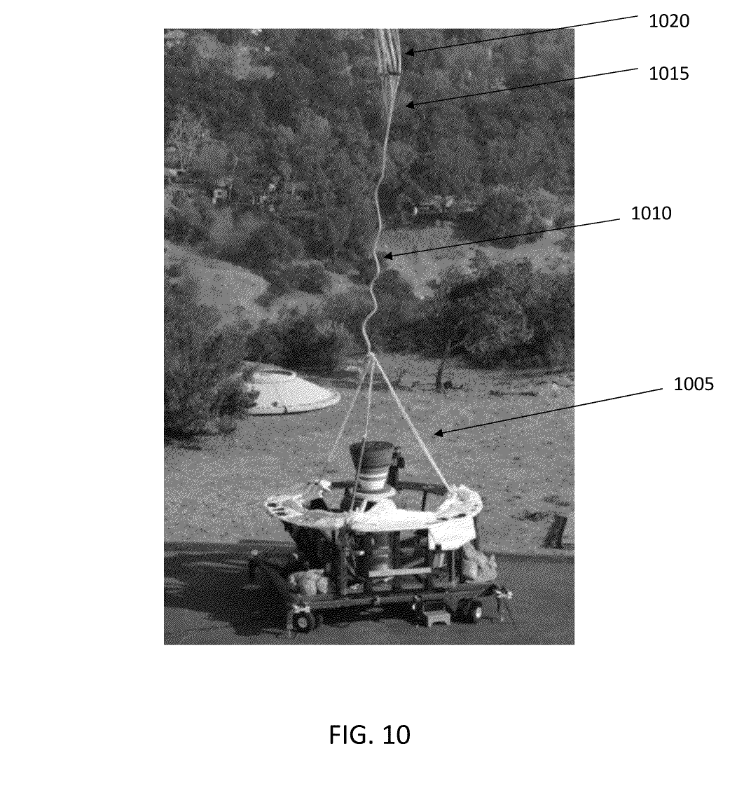

FIG. 10 illustrates a successful dynamic deployment of the braided riser-bridle. This deployment demonstrated the aforementioned advantages of elimination of the metallic confluence. In this exemplary test, all of the various sections of a continuous tensile systems can be seen, three bridle legs (1005), a single riser (1010), first cascade of 12 strands out of the single riser (1015), and the final cascade of the individual 96 suspension lines (1020) heading upward to the parachute canopy (not shown) are all visible.

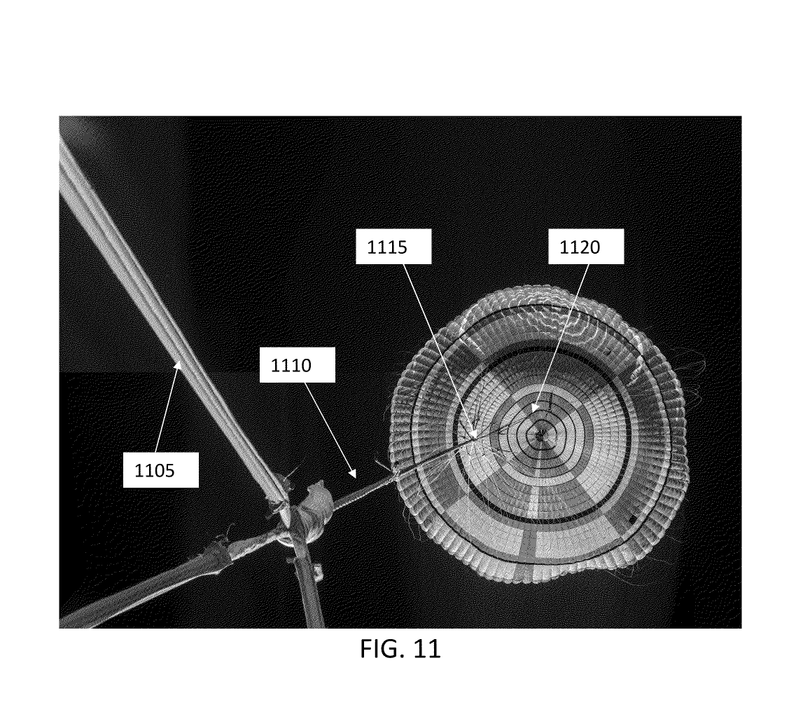

FIG. 11 illustrates an exemplary braided riser-bridle, also shown in FIG. 10 during supersonic parachute testing. This nearly continuous tensile system was structurally qualified to the required loads and dynamics of the supersonic parachute flight. FIG. 11 shows the three bridles (1105), the single riser (1110), the 12 strands transitioning out of the single riser (1115) and finally the 96 individual suspension lines going up toward the parachute (1120).

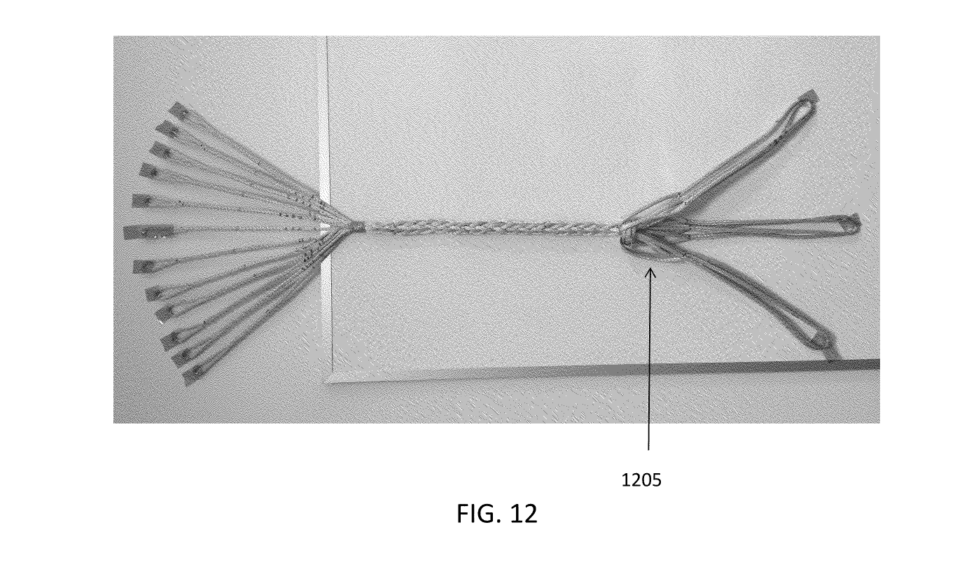

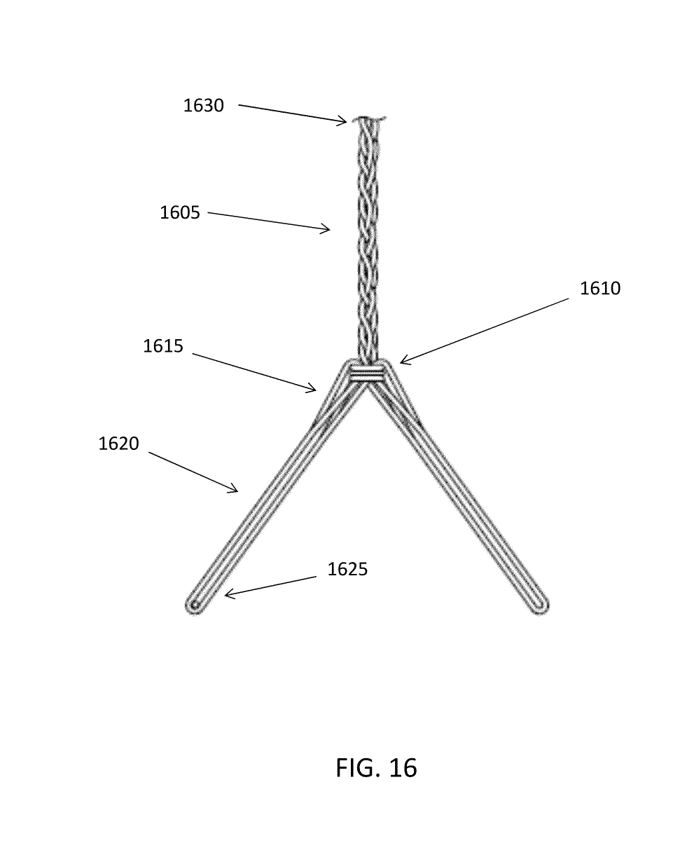

FIG. 12 illustrates a braided riser bridle with the confluence wrap (1205) that was used in testing. FIG. 16 defines the various components of the braided riser bridle including details of the confluence wrap. In FIG. 16, the braided riser (1605) is visible, as well as the confluence wrap (1610), a jumper (1615), and one of six legs (1620). Part (1625) goes to the parachute, while part (1630) attaches to the payload.

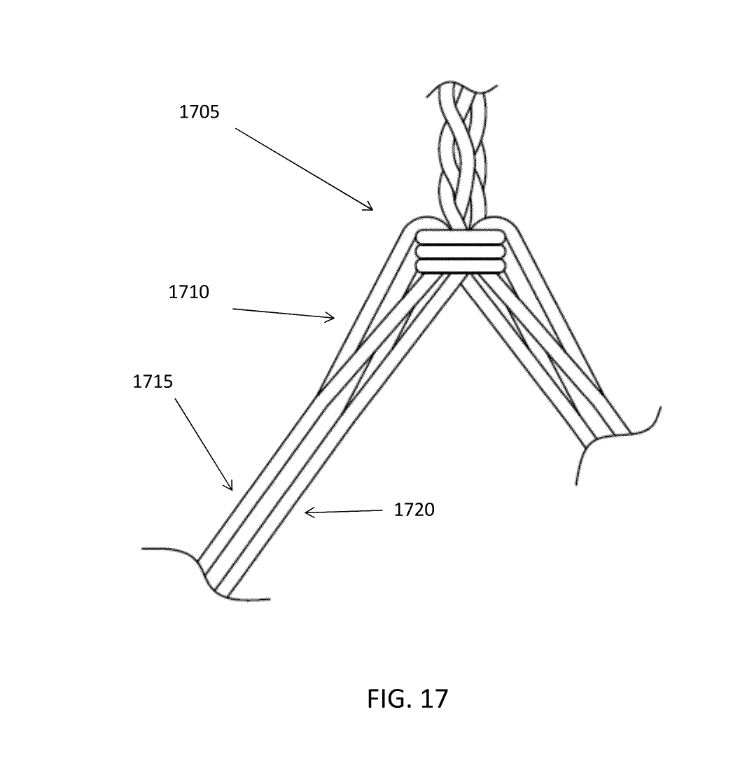

FIG. 17 shows a close up of the confluence wrap (1705) and jumper (1710) design. The jumpers keep the wrap (1705) from sliding up the braided section of the riser. This jumper (1710) is structurally connected to one of the bridle legs (1715), wraps around the confluence wrap, and then is structurally connected to another of the bridle legs (1720). In this embodiment, the bridle legs (1715, 1720) that a single jumper is connected to are made up of a single continuous cordage.

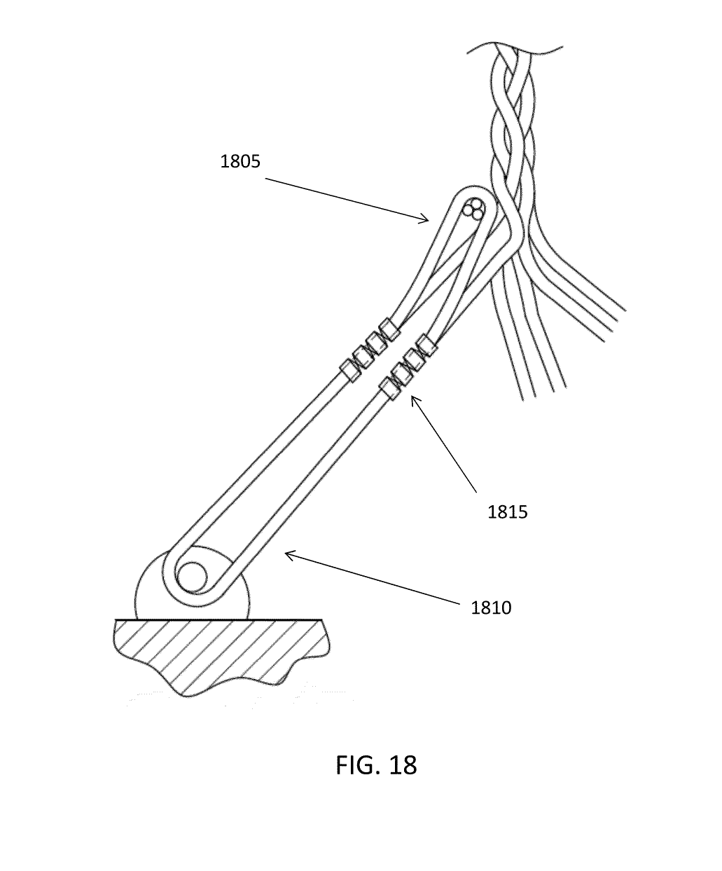

FIG. 18 illustrates the details of the design shown in FIGS. 12, 16 and 17. The jumper (1805) is shown connecting structurally to the continuous bridle leg via an insertion termination technique which is commonly seen in fabrication of eye-splices using stranded cordage. Locking thread (1815) can be used to secure the jumpers to the legs.

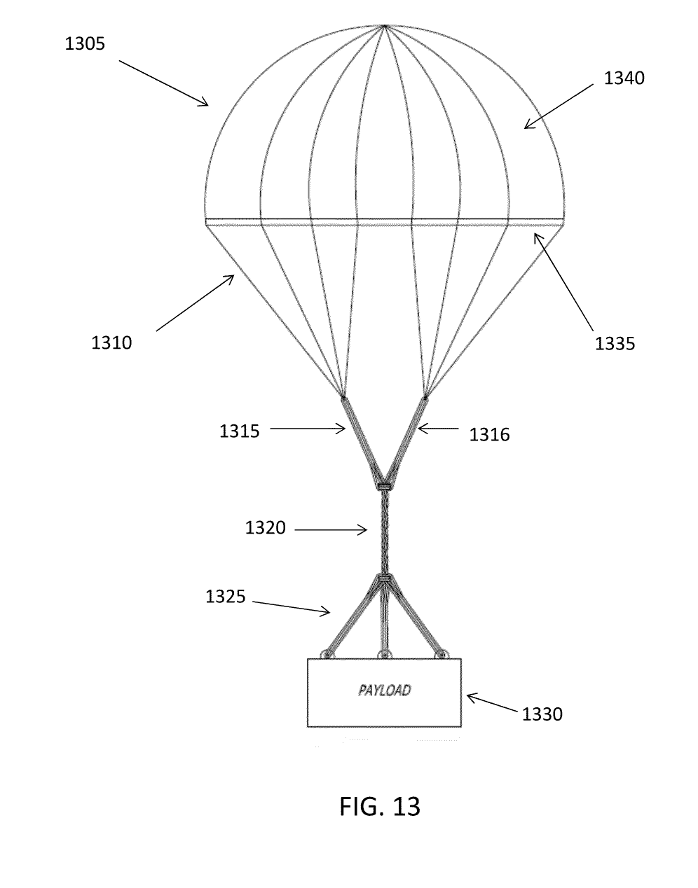

FIG. 13 illustrates an exemplary design of a continuous tensile parachute structure with multi-stage braiding. In this exemplary design the continuous suspension lines (1310), also used as the parachute's radial members (1305), cascade in to two braided sections (1315, 1316) as shown as the stage one braiding. These two braided sections (1315, 1316) are then braided into a single riser section (1320) at stage two braiding. Subsequently the stage three braiding (1325) coming out of the single riser section (1320) breaks out to the bridle legs that connect to the suspended payload (1330). In this design all tensile strands are continuous and do not have any joints until the end termination at the payload interface. More specifically starting at the vent of the parachute, the radials that emanate from it travel down the canopy become the suspension lines once they pass by the skirt band (1335) at the leading edge of the canopy. Those suspension lines are braided together, with the use of a confluence at the transition, into a smaller number of braids than there are suspension lines, creating a cascade. Those then in return are braided once again into a single riser with confluences on each end of the single riser section. At the bottom of braided riser, the strands are braided into the required bridle leg number as needed by the payload interface. A broadcloth (1340) is used for the canopy. These elements form a continuously braided parachute suspension system.

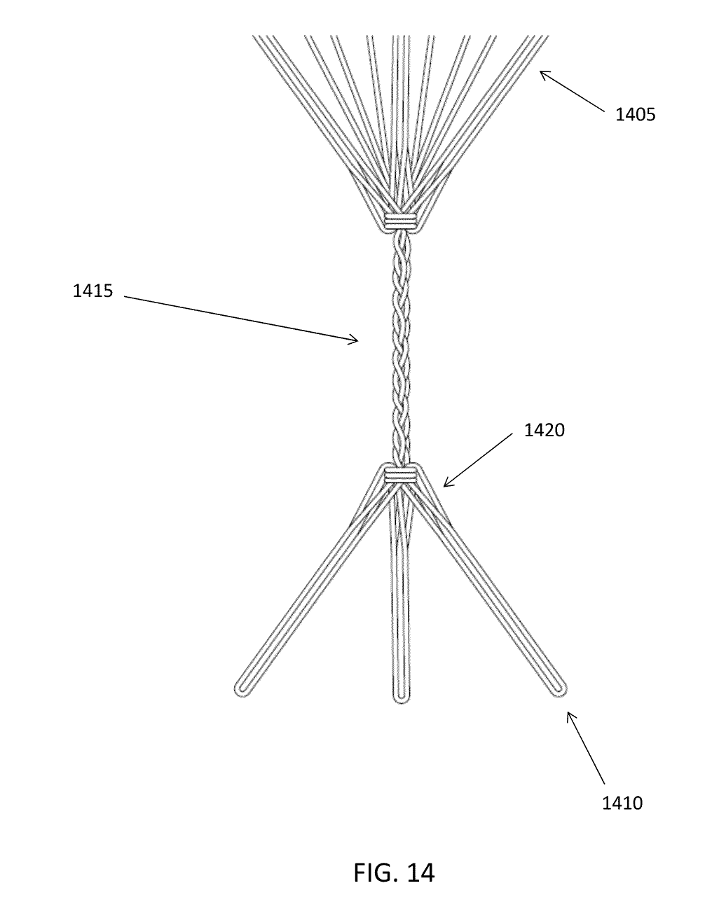

FIG. 14 illustrates the use of six strands to generate a 12-strand braid. One end (1405) of the system attaches to the parachute, while the other end (1410) to the payload. Twelve strands (1415) are braided together. A standalone confluence tether (1420) is visible.

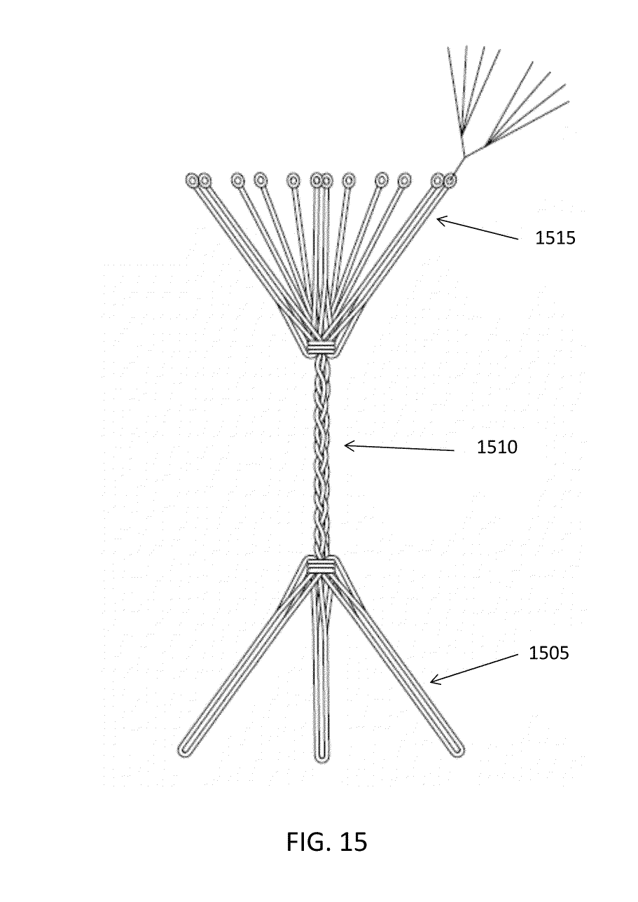

FIG. 15 illustrates the use of 12 strands to generate a 12-strand braid. In this embodiment, four parallel ropes (1505) are used for each leg. In this embodiment, each rope is 30,000 lbs strength, for a total of 120,000 lbs break strength per leg. The ropes are braided together to form a twelve strand herringbone braid (1510) with a break strength of 360,000 lbs. Each of the ropes (1515) is then continuing to the canopy. The rope can have a Kevlar baseline.

In some embodiments, the ropes are braided from one end of the system to the other, for example from the payload to the parachute canopy. In other embodiments, the ropes could be braided so as to start from one end, being braided to the other end, and return to the opposite end. For example, if four legs are present at the payload, two of the legs could comprise ropes that are braided into a braid, then arrive at the canopy, and are continuously braided going back down the braid and separate to form the other two legs at the payload. In some embodiments, the ropes have a minimum break strength of 16,000 lbs.

The person of ordinary skill in the art will understand from the present disclosure that, in some embodiments, the continuous tensile system is braided from a plurality of ropes, and comprises a plurality of bridle legs braided from the plurality of ropes; a riser braided from the plurality of bridle legs; a first confluence joint between the plurality of bridle legs and the riser; and a second confluence joint between the riser and a plurality of extension lines, each extension line being a rope of the plurality of rope which is unbraided from the riser. In some embodiments, each rope of the plurality of ropes is continuous from a beginning of the plurality of bridle legs to an end of the plurality of extension lines that is from the payload to the canopy.

This technology is readily available for current and future NASA and industrial work. Future large parachute systems can now take advantage of this technology to increase robustness, mitigate deployment dynamics and save on parachute system mass. This technology has been developed as part of the LDSD program and has successfully been tested, implemented and flown on a supersonic flight dynamics test.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The references in the present application, shown in the reference list below, are incorporated herein by reference in their entirety.

What is claimed is:

1. A continuous tensile system braided from a plurality of ropes, the system comprising:
a plurality of bridle legs braided from the plurality of ropes;
a riser braided from the plurality of bridle legs;
a first confluence joint between the plurality of bridle legs and the riser; and
a second confluence joint between the riser and a plurality of extension lines, each extension line being a rope of the plurality of rope which is unbraided from the riser.

2. The system of claim 1, wherein each rope of the plurality of ropes is continuous from a beginning of the plurality of bridle legs to an end of the plurality of extension lines.

3. The system of claim 1, wherein at least one rope of the plurality of ropes is continuous from a beginning of a first bridle leg of the plurality of bridle legs through an end of a first extension line of the plurality of extension lines to a beginning of a second bridle leg of the plurality of bridle legs.

4. The system of claim 2, wherein the first or second confluence joint is a wrapping of cordage wrapped around the plurality of ropes.

5. The system of claim 4, wherein the first or second confluence joint further comprises a series of locking half-hitches.

6. The system of claim 2, wherein first or second confluence joint comprises multiple wraps of stranded braid.

7. The system of claim 6, wherein the multiple wraps are constrained to the plurality of bridle legs via jumpers.

8. The system of claim 7, wherein the jumpers are spliced into the plurality of bridle legs.

9. The system of claim 1, wherein the plurality of bridle legs comprises three bridle legs.

10. The system of claim 9, wherein each bridle leg is braided from four ropes and the plurality of extension lines comprises twelve extension lines.

11. The system of claim 10, wherein each rope has a minimum break strength of 16,000 lbs.

12. The system of claim 1, wherein the riser is a two-over-two-under braid.

13. The system of claim 1, further comprising a parachute attached to the plurality of extension lines.

14. The system of claim 13, wherein the plurality of extension lines continuously transitions into canopy radials of the parachute.

15. The system of claim 14, wherein the plurality of bridle legs are configured to attach to a payload.
